(19) United States
(12) Patent Application Publication
(10) Pub. No.: US 2005/0051392 A1
(43) Pub. Date: Mar. 10, 2005

(54) Rotor disc for a disc brake

(76) Inventors: Jonathan Layfield, Cheshire (GB); Daniel Joseph Rynehart, Cheshire (GB)

Correspondence Address: SALTER & MICHAELSON;THE HERITAGE BUILDING, 321 SOUTH MAIN STREET, PROVIDENCE, RI, 029037128, US

(21) Appl. No.: 10/491,294

(22) PCT Filed: Oct. 1, 2002
(86) PCT No.: PCT/GB02/04427

(30) Foreign Application Priority Data
Oct. 2, 2001 (GB) 0123618.1

(51) Int. Cl. F16D 65/10

(52) U.S. Cl. 188/218 XL

(57) ABSTRACT

A rotor disc (1) for a disc brake and the like comprises a circular substrate (2) made of a thermally conductive material, and two superposed coating layers (3) and (4) disposed on both outer circular faces of the substrate. The outer coating layer (3) is made from a high thermal conductivity and high wear resistant material such as carbon silicon carbide composite or metallic type material. The inner coating layer (4), is made from a thermally insulating material such as zirconia or other ceramic material. The dimensions of the substrate and layer and the material from which they are made may be tuned for optimum performance. The inner layer (4) operates to protect the substrate from the heat and high temperatures generated at the outer surface of the disc (1) in use.

The present invention relates to a rotor disc, particularly, but not exclusively for a disc brake and the like.

Traditionally, brake discs have been made of cast iron. Cast iron exhibits the necessary thermal and strength characteristics for this purpose. A disadvantage, however, is its weight. In an average motor vehicle with disc brakes on all four wheels the rotor discs of the brakes may add 40 kg to the weight of the vehicle. This weight is carried permanently around with the vehicle, although the brakes may be used relatively infrequently, thus adding to fuel consumption and emissions. Making discs of other lighter materials has been proposed but so far a satisfactory solution has not yet been found. For example, aluminium has been suggested but although its thermal properties are good they are not as good as those of cast iron. These poorer thermal characteristics adversely affect the performance of the material as a rotor disc.

According to the present invention there is provided a composite rotor disc comprising a substrate made of a thermally conductive material, a first coating layer on at least one circular face of the disc, the first coating layer being made of a thermally insulating material and a second coating layer superposed on the first coating layer, the second coating layer being made of a wear resistant, thermally conductive material whereby the substrate is protected from heat generated at the circular surface of the disc.

In a preferred embodiment of the invention, the substrate is advantageously aluminium or other suitable metal or metallic alloy. The first coating layer may advantageously be Zirconia or other ceramic. The second coating layer may advantageously be a carbon-silicon carbide composite or other metallic alloy. The thicknesses of the layers and substrate advantageously lie in the following ranges. Layers 0.01 to 2.00 mm substrate 5-40 mm

In order that the invention may be more clearly understood embodiments thereof will now be described, by way of example, with reference to the accompanying drawings, in which:

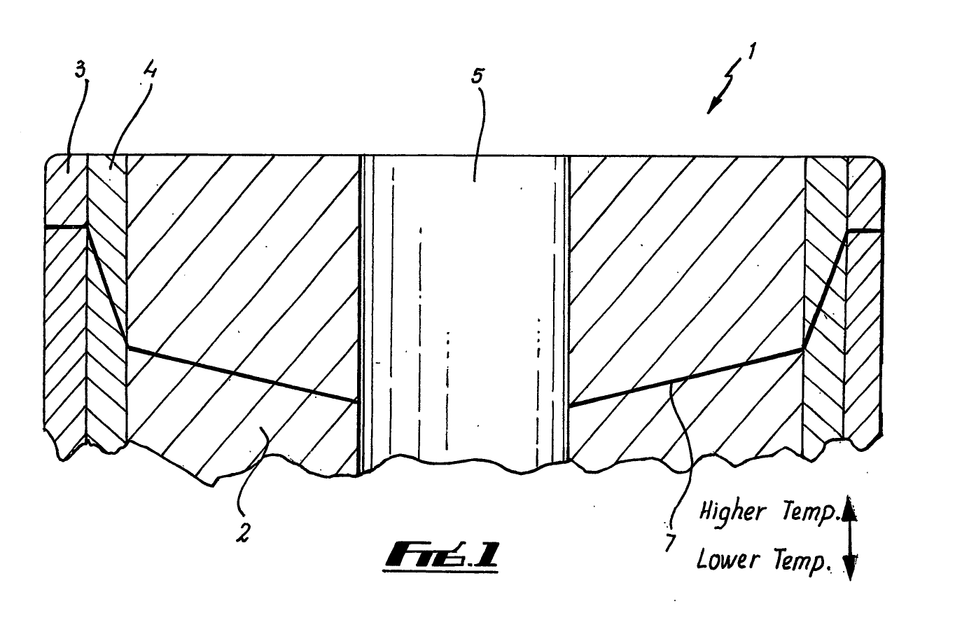

FIG. 1 shows a cross section through a part of a rotor disc according to the invention,

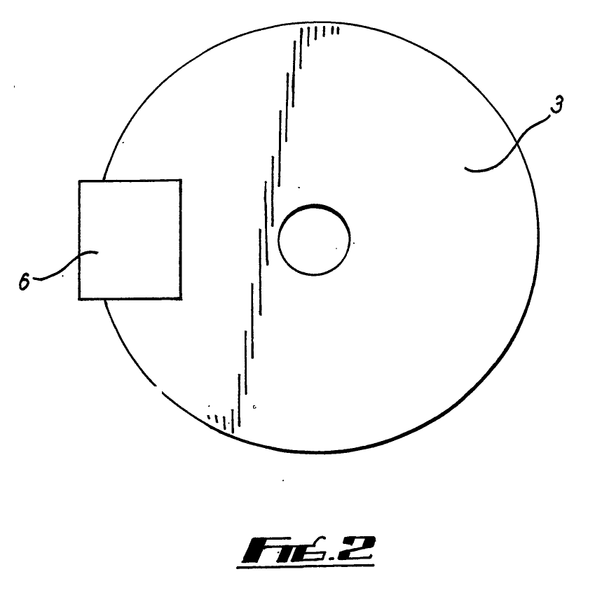

FIG. 2 shows a front elevational view of the rotor disc of FIG. 1,

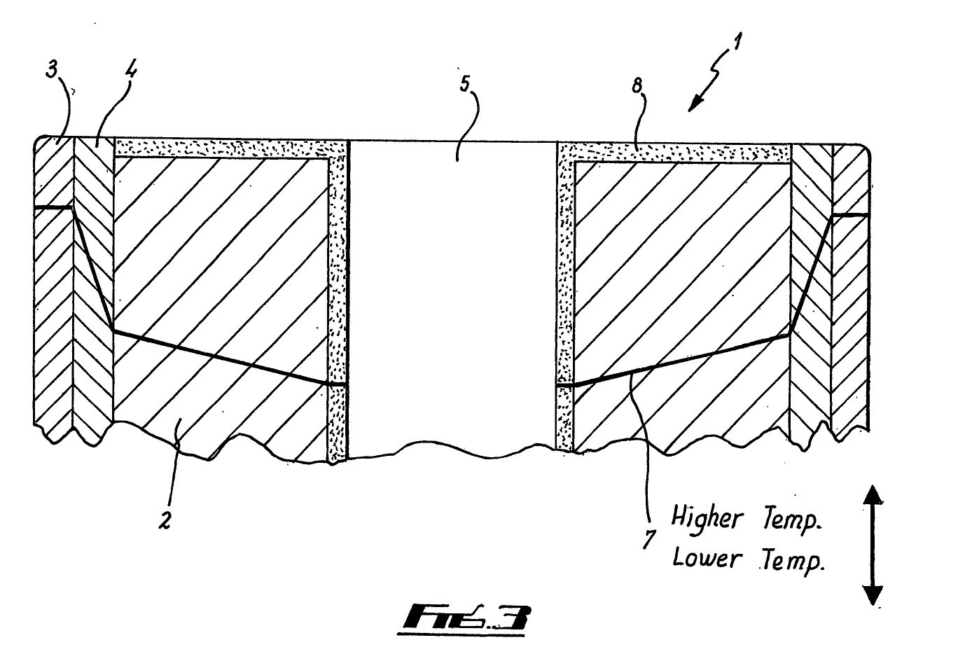

FIG. 3 shows a cross-section of a modification of the rotor disc of FIGS. 1 and 2, and

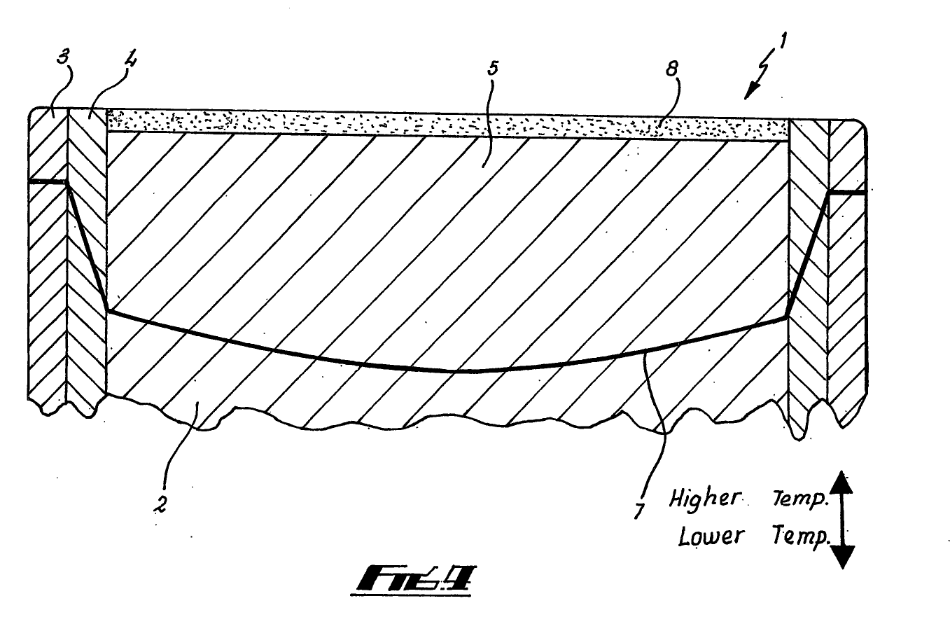

FIG. 4 shows a cross-section of a further modification of the rotor disc of FIGS. 1 and 2.

Referring to FIGS. 1 and 2 the rotor disc is indicated generally by the reference numeral 1 and comprises a circular substrate 2 and two superposed coating layers 3 and 4 disposed on both outer circular faces of the substrate. The substrate is vented at 5 so that air may circulate through the substrate to cool the substrate. The substrate 2 is made from a low density but high thermal conductivity material such as aluminium or other suitable metal or metallic alloy. The outer coating layer 3 is made from a high thermal conductivity and high wear resistant material such as a carbon-silicon carbide composite or metallic-type material. The inner coating layer 4 is made from a thermally insulating material such as zirconia or other ceramic material.

In operation under braking conditions heat is generated on both surfaces of the disc due to friction between the brake pad shown diagrammatically at 6 and the rotor disc 1 as the disc 1 rotates causing the temperature of the disc 1 to rise. Heat is lost from the disc 1 by conduction convection and radiation. Heat lost by conduction is to the surrounding air and through the material of the outer layer 3 to inner layer 4 and through that layer to the substrate 2 beneath. Heat lost by convection is to the surrounding air as the air moves relative to all surface of the disc including those opening to the vent 5. Heat lost by radiation is lost from all hot surfaces. An exemplary temperature profile through the rotor disc 1 is shown at 7. The temperature is at its maximum on both outer surfaces of the disc 1 where the heat is generated through the friction between the disc brake pad 6 and those surfaces. Heat is conducted relatively easily through the outer layers 3, which are made of a highly thermally conductive and wear resistant material, to the inner layers 4, and the fall in temperature through those layers is correspondingly small. Heat conduction through the inner layers 4, which is made of a thermally insulating material, is restricted and, as compared with the outer layer there is a greater fall in temperature. The inner layers 4 therefore operate to protect the substrate from the heat and high temperatures generated at the outer surfaces of the disc 1. The temperature at the interface between the substrate 2 and the inner layers 4 is much less than that between the outer and inner layers 3 and 4 and it continues to fall across the material of the substrate heat flowing through the substrate being removed at the surfaces adjoining the vent 5 by conduction, convection and radiation.

The thickness of the layers 3 and 4 is advantageously in the range 0.05 to 5.00 millimetres, preferably in the range 0.01 to 2.00 millimetres and in this example outer layers 3 are 1.0 millimetres thick and inner layers 4 are 0.5 millimetres thick. The thickness of the substrate lies in the range 5 to 40 millimetres. By appropriately choosing the dimensions of the layers and substrate and the material from which the layers and substrate are made the thermal behaviour of the rotor disc may effectively be ‘tuned’ for optimum operational performance.

In a modification, a protective layer may be disposed over the outer cylindrical surface and adjacent the vent of the substrate as shown in FIG. 3 to protect the substrate against oxidation in all regions not coated by layers 3 and 4. In this modification parts equivalent to the parts of the embodiment of FIGS. 1 and 2 bear the same reference numerals. With the above described arrangements heat maybe conducted around the outer layer(s) 3 and lost by convention from the surface thereof. Heat from the outer layer(s) may also be dissipated by controlled conduction through the inner layer 4 and through the substrate 3 and lost by convention from the surfaces adjacent the vent 5 in the substrate.

Although the disc has been described with a vent, the vent may be dispensed with. Such an arrangement is illustrated in FIG. 4. In this figure parts equivalent to parts in FIGS. 1 to 3 bear the same reference numerals.

It will be appreciated that the above embodiment has been described by way of example only and that many variations are possible without departing from the scope of the invention.

1. A composite rotor disc comprising:
a substrate made of a thermally conductive material;
a first coating layer on at least one circular face of the disc, the first coating layer being made of a thermally insulating material; and
a second coating layer superposed on the first coating layer, the second coating layer being made of a wear resistant, thermally conductive material;
whereby the substrate is protected from heat generated at the circular surface of the disc.

2. The composite rotor disc of claim 1, wherein the substrate is metal.

3. The composite rotor disc of claim 1, wherein the metal is aluminum.

4. The composite rotor disc of claim 1, wherein the substrate is a metallic alloy.

5. The composite rotor disc of claim 1, wherein the full coating layer is a ceramic.

6. The composite rotor disc of claim 5, wherein the ceramic is zirconia.

7. The composite rotor disc of claim 1, wherein the second coating layer is a metallic alloy.

8. The composite rotor disc of claim 7, wherein the metallic alloy is a carbon-silicon carbide composite.

9. The composite rotor disc of claim 1, wherein the thickness of the substrate lies in the range 5 to 40 millimeters.

10. The composite rotor disc of claim 1, wherein the thickness of the layers lies in the range 0.05 to 5.00 millimeters.

11. The composite rotor disc of claim 1, wherein the thickness of the layers lies in the range 0.01 to 2.00 millimeters.

12. The composite rotor disc of claim 1, wherein the first coating layer is 0.5 millimeters thick.

13. The composite rotor disc of claim 1, wherein the second coating layer is 1.00 millimeter thick.

14. The composite rotor disc of claim 1, wherein the substrate is vented.

15. The composite rotor disc of claim 1, wherein a protective coating is disposed over the outer cylindrical surface.
